(19) United States
(12) Patent Application Publication
(10) Pub. No.: US 2003/0210962 A1
(43) Pub. Date: Nov. 13, 2003

(54) Speed chisel-edgeless common bit

(76) Inventor: Hsin-Tien Chang, Taipin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/139,230

(22) Filed: May 7, 2002

(51) Int. Cl. B23B 51/02

(52) U.S. Cl. 408/211

(57) ABSTRACT

The present invention provides a powerful drilling common bit, and more particularly to a speed chisel-edgeless common bit, which has central cutting edge so as to reduce the cutting resistance and to improve the stability. The present invention includes a stem having two inter-alternative coordinated cutting slots, a V-shaped notch at the tip central overlapping portion of said both cutting slots to make two inserts overlap each other at the back corner tips as combination to make the center of the bit have cutting function for reducing the cutting resistance and having accurate central location, further to improve the ratio of L/D, simultaneously having high drilling speed and high feed rate and rapid chip removal.

### BACKGROUND OF THE INVENTION

1. Field of the Invention

The present invention relates to a powerful drilling common bit, and more particularly to a speed chisel-edgeless common bit, which has cutting edge replacing chisel-edge in order to reduce axial feed drag turbine, and have higher position accuracy and weakening function for improving stability, further to extend the length of auger stem for adapting itself to depth drilling, in step edge design, the cutting edges are arranged into different stages to form step cutting so that the chip is cut shorten to the advantage of smooth chip removal.

2. Description of Prior Art

In accordance with the conventional auger bit 10, especially to wide-aperture solid boring head, as shown on FIG. 1 and FIG. 2, the cutting edges have to be remedied in grinding by a drill grinding machine or hand-holding grinding, therein it exists following drawbacks:

1. Said bit is made of high-speed steel, which has poor wear-ability shortcoming, therefore the cutting surface speed is slow, and stock-removing efficiency is naturally poor.

2. the conventional bit has not chip-breaker in design, the chip is not broken easily, usually so as to create continuous chips—long chips so that chip removal is difficult, and the chip room is blocked, especially in depth boring processing, the operator has to retract often, to occur increase cutting time and production cost.

3. renewing grinding process is not easy, it commands that the skilled worker remedies the bit in hand-holding in grinding, but the lip angle unbalance often happens unexpectedly to cause cutting-edge unequal, further to enlarge the desired aperture; the advancers remedy bits by a drill grinding machine for getting more accurate lip angle and cutting-edges, but it will take more time, and the production cost is gone up by the expensive equipment.

4. said conventional bit typically has a chisel-edge that have not any cutting function in processing but bigger drag, as shown in FIG. 3 and FIG. 4, said FIG. 3 is an axial thrust profile, namely a scatter-gram of said chisel-edge 12 and said cutting edges 11 coordinating to said axial thrust, said FIG. 4 is a scatter-gram of said cutting edges 11 and chisel-edge 12's level action force distributing state, therein said cutting edges 11 have cutting function, so the axial and level component forces are smaller, but said chisel-edge (static point) 12 has not any cutting function, therefore its axial and level thrusts are very strong, so as to affect relatively drilling capability and axial feed rate, further to increase the cutting processing time and the production cost.

Referring to FIG. 5, 5a and 5b, a replaceable bit 20, made by KENNAMETAL HERTEL Co., has a retaining slot 21 for holding a replaceable auger head 22 in by a retaining bolt 23 extended out from the auger stem 24 in said retaining slot 21; although this replaceable auger head mechanism can make the auger stem be used repeatedly by replacing the replaceable auger head 22, but the single head piece has high price and unrenewable drawbacks, so that this kind of bit is not used widely.

Referring to FIG. 6, another kind of replaceable bit in the market is attached with different shaped replaceable inserts—outside cutting insert 31, inside cutting insert 32 and a central drill 33, within said inside and outside cutting inserts 32 31 are replaceable inserts, although they can be replaced rapidly, and located accurately, but also there are following drawbacks existing:

1. Said central drill 33 has said chisel-edge yet, so its axial and level component thrusts are so bigger that they affect their cutting capability.

2. it is a single-edge cutting in mechanism design, said inside and outside cutting inserts 32 31 are arranged in unbalance placing, and not same in shapes and in cutting positions, hence the drilling process is presented in single-cutting method, so that the cutting resistances are quite great, further efficiently slowing down the feed speed and cutting speed relatively.

3. due to the unbalance arrangement of said inside and outside cutting inserts 32 31, the tool thrusts are unbalance too, so the tool will be shocked easily, and the cutting hole's size can be kept in accurate hardly, and the roughness of surface are poor.

4. said inserts are easily broken, referring to FIG. 7, the both sides of said central drill 33 (marked portions by arrows) and the inside of said inside cutting insert 32 and the outside of said outside cutting insert 31 (the portions marked by arrows) are broken off easily occurred by unbalance resistances, due to the fragileness of said inserts, the tool's service life will be shortcut, and the ratio of length of stem (L) and the diameter of the bit (D) will be limited in small, so L/D is under 7, so that it can be used in a narrow range in application.

Referring to FIG. 8, it is an other single-flat inserted drill, the insert 41 has a slot 42 at the bottom side for locating on the stem by secured with screws on the stem, but said chisel-edge is still remained in said flat insert 41 so that it's feed speed and cutting speed are still affected by the axial and level component thrusts, on the other hand, said flat insert is very expensive, further to cause the production cost going up, and after the flat insert 41 is worn out, it will be given up, and unable to be remedied in grinding for renewing, so it is an un-economic insert.

The inventor regard up said drawbacks—like chisel-edge existing to affect the axial and level feed and cutting capabilities, and expensive inserts, and unbalance cutting resistances and so on, and take advantage of the experiences of manufacturing and selling inserted drill in many years, finally invent the present invention through several times of experiments and innovations.

### OBJECTS AND SUMMARY OF THE INVENTION

It is therefore a main object of the present invention to provide a speed chisel-edgeless inserted bit, in which cutting edges having cutting function replace said chisel-edge to reduce the resistances of feed and cutting, meanwhile have high accurate locating position feather, and weakening function for improving stability, further to improve processing accuracy and production capability, and to decrease production cost.

### BRIEF DESCRIPTION OF THE DRAWINGS

FIG. 1 is a side view of the conventional common drill.

FIG. 2 is a top-end side view showing of FIG. 1.

FIG. 3 is a scatter-gram showing the axial thrust of the conventional common drill.

FIG. 4 is a scatter-gram showing the level thrust of the conventional common drill.

FIG. 5, 5a and 5b is a series scheme of the inserted drill provided by KENNAMETAL HERTEL Co.

FIG. 6 is a side view of a conventional drill combined with central bit and inserts.

FIG. 7 is a scheme showing the friable portions of the conventional drill combined with central bit and inserts.

FIG. 8 is a side view of a conventional flat inserted drill.

FIG. 9 is a solid view of the present invention.

FIG. 10 is a side view showing the combined state of the present invention.

FIG. 11 is an enlarged view showing the tip end of the present invention.

FIG. 12 is a top-end side view of the present invention.

FIG. 13 is a side view showing an embodiment of drilling wide aperture hole of the present invention.

FIG. 14 is a side view showing another embodiment of applying multi-edge insert of the present invention.

FIG. 15 is an enlarged view showing the inner cutting edge portion of the multi-edge insert embodiment of the present invention.

FIG. 16 is a top-end side view showing the multi-edge insert embodiment of the present invention.

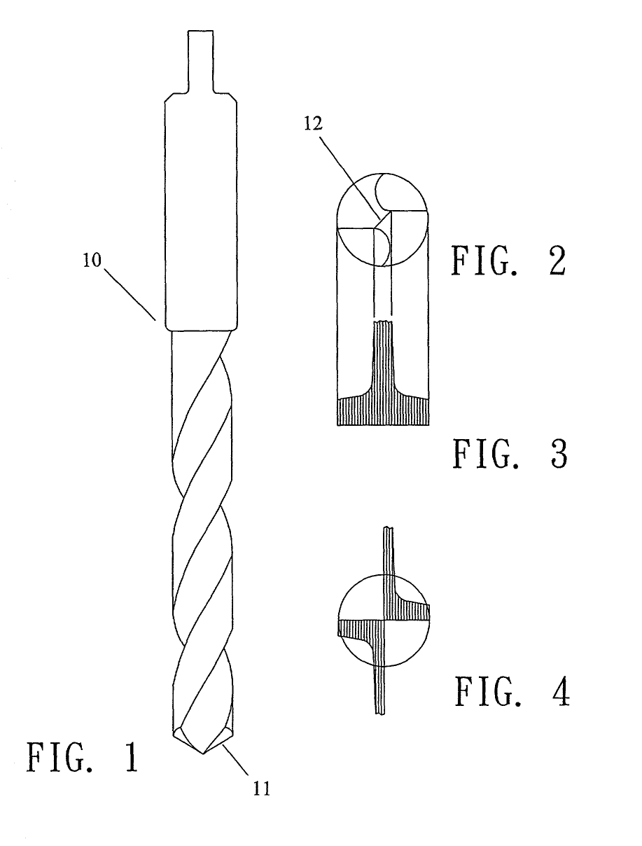

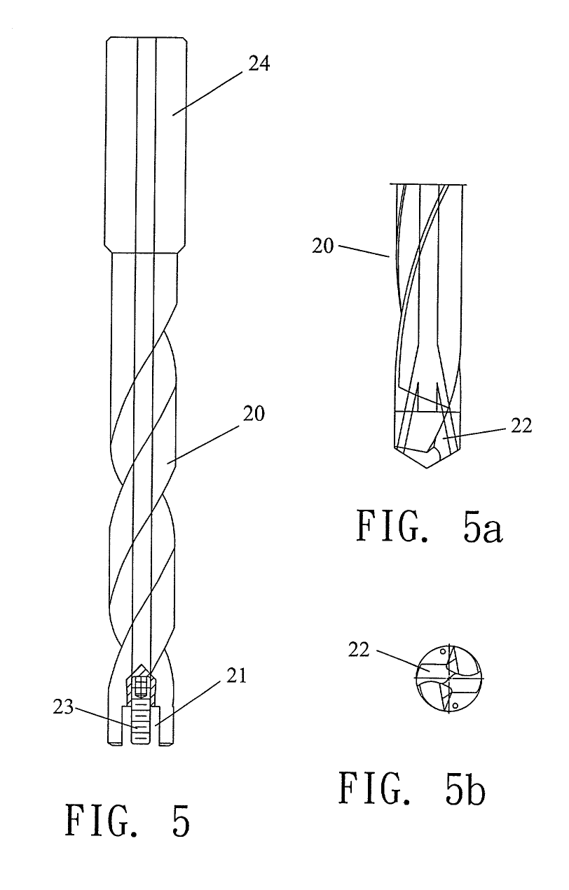

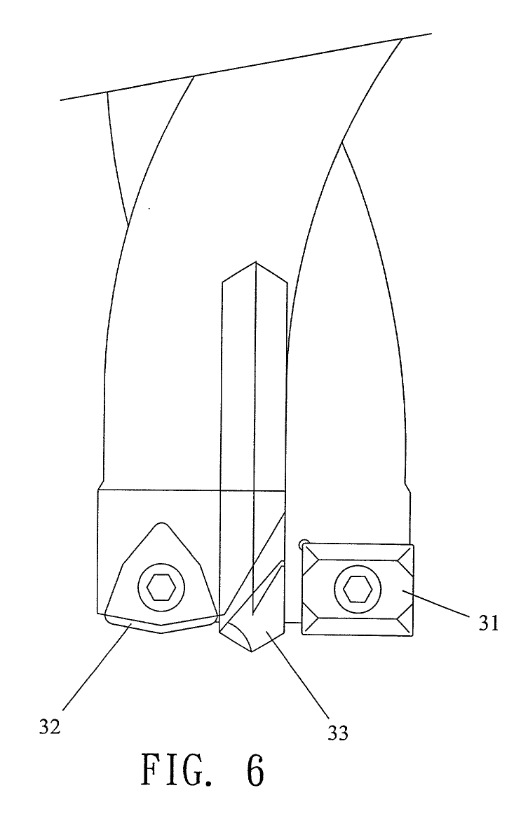

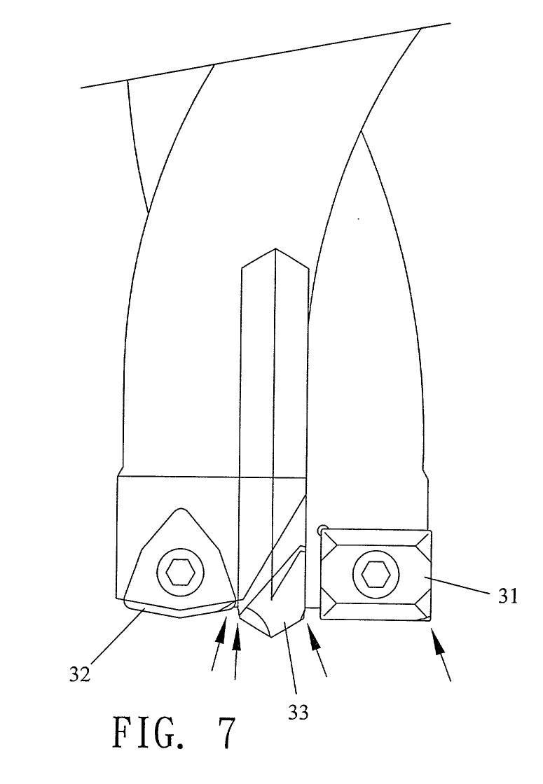

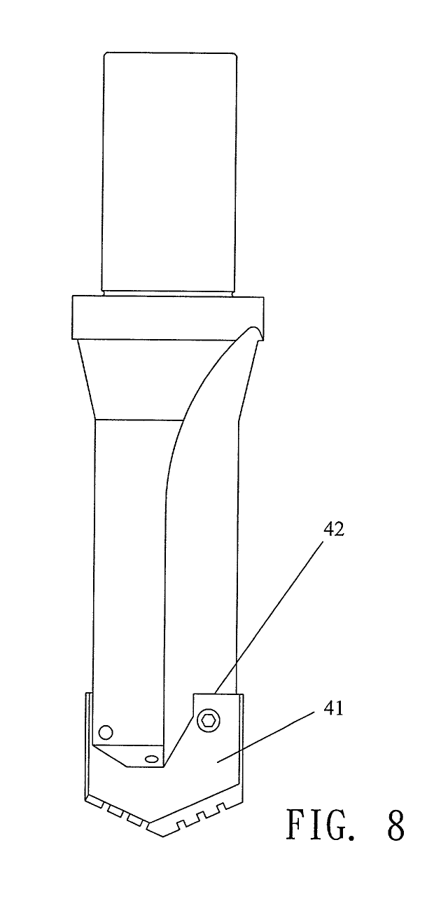

### DETAILED DESCRIPTION OF PREFERRED EMBODIMENTS

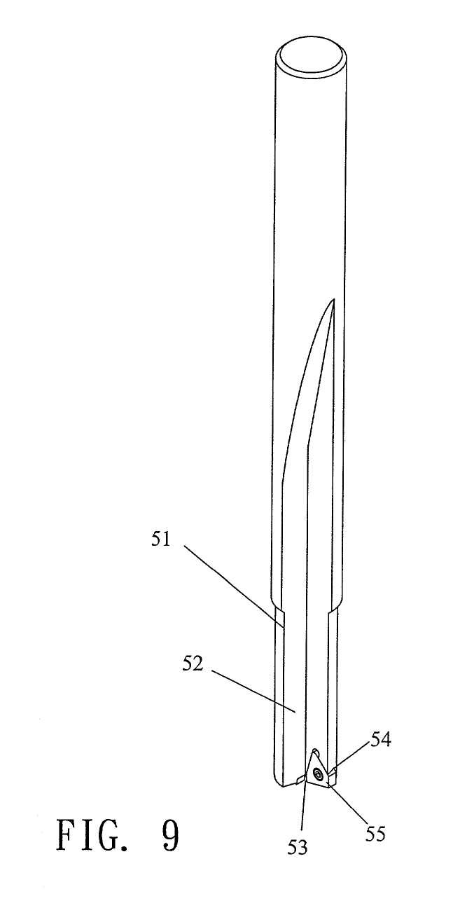

Referring to FIG. 9 to FIG. 12, the present invention includes a stem 51 having two inter-alternative coordinated cutting slots 52, a V-shaped notch 53 at the tip central overlapping portion of said both cutting slots 52, and two holding slots 54 and two screwing holes built upon the tip ends of said cutting slots 52 separately for retaining two inserts 55 individually.

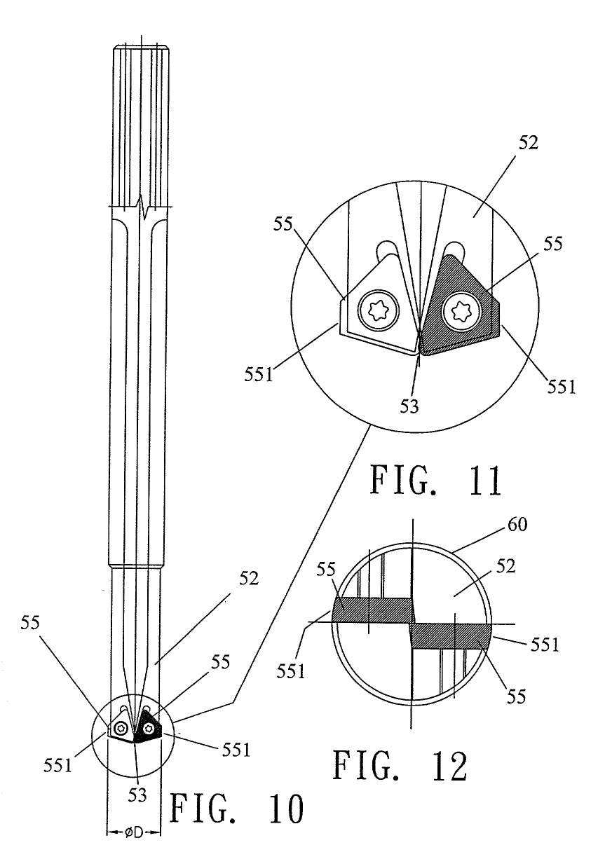

Referring to FIG. 10 to FIG. 12, two inserts 55 are secured in balance state for getting balance uniform resistances, in order to improve the stability and to increase feed and cutting speeds too, and the size of the side 551 of said insert 55 depends on the size of the bit, and the edge portion's size (including back angel) of said side 55 are determined by the size of the diameter ΦD of boring hole so that the back side of said side 551 un-touches with the side wall of boring hole 60 (cut by edge), therefore said back side of said side 551 is designed into curved surface as shown in FIG. 12, thereby as drilling with the insert, said curved back side of side 551 is simultaneously supported by the inside wall of said boring hole 60 for getting steady-state function; additionally, said overlapped V-shaped notch 53 built on the tip ends of said inter-alternative cutting slots 52 makes the inserts 55 overlap a bit (about 0.1 mm) each other at the back corner tips as combining to form an internal central edge by the both back corner tips, it not only eliminates the conventional chisel-edge (static point), but also the internal edges of said back tips of said inserts can locate the central position simultaneously as high spinning cutting accurately, besides improving cutting capability of the bit, meanwhile the stability of the bit is improved greatly too without any vibration and offset of the center, in addition with the stability function of the both sides of said inserts and the inside wall of the boring hole as drilling, the location of center and the stability of the bit are improved in quite high level, thereby the cutting speed and axial feed speed are increased, and the axial and level component resistances generated by the conventional chisel-edge are eliminated completely, therefore the ratio (L/D) of the length (L) of the stem and the diameter (D) can get 10, particularly to suit depth hole processing with high advanced stage and practicability and utility value for industry.

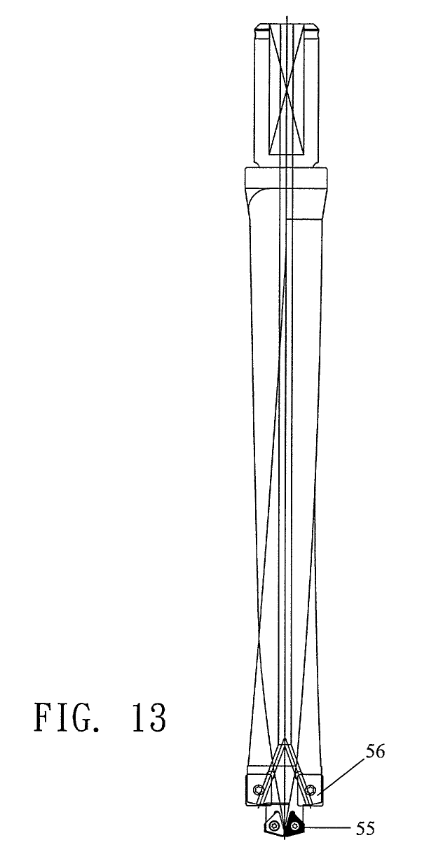

Referring to FIG. 13, for suiting to drilling the wide aperture of hole, the inserts are arranged into step arrangement design, as shown in drawings, the back corner tip ends of two inserts 55 located on the tip central position construct center location and small aperture drilling functions, and the inserts 56 located on the higher stage construct to enlarge the bored small hole and to cut to full size, said step insert arrangement not only disperses the cutting resistances exerting on the inserts, but also break off the chips to reduce the volume of them for facilitating cutting removal without any block, further to improve the feed rate and the cutting speed without taking the advantage of retracting chip removal any more, therefore save processing time and production cost, and improve the competitive capability.

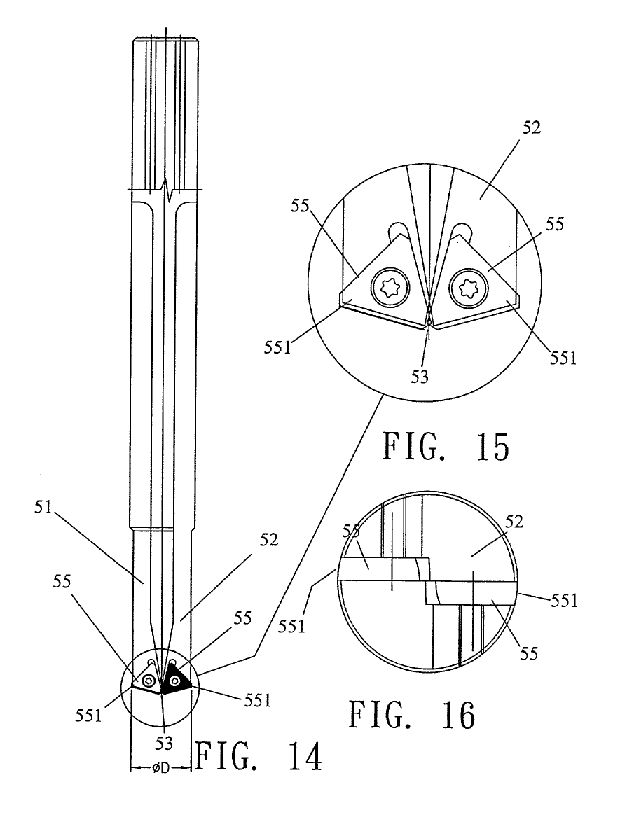

Referring to FIG. 14 to FIG. 16, the inserts 55 may have multi-inner-edge in this embodiment, therein every corner is shaped as same as said side 551, so that the overlapped portions of said two inserts 55 at the central tip of said stem 51 form an inverted V-shaped inner cutting edges taking place of said curved inner cutting edge, within the tilted cutting edge having still cutting function instead of the conventional no-cutting effect chisel-edge (static point) makes said side 551 lose cutting function as locating on the outside, but have supporting function, hence the cutting edge will not be blunted; when said side 551 is located on the center of said stem shift, it plays the role of inner edge having cutting function; when said inner edge and the bottom edge are blunted, said insert 55 can be shifted an other corner to continue using; the benefit of making said insert 55 into multi-edge is on bringing the multiple edges into full play and saving the production cost.

In addition, when the boring aperture is increased, just need to change the location of the inserts 56 on the stem (turned to the outward) properly, depending on the change of said boring aperture, so the cutting aperture can be changed so that the size of cutting is become flexible deeply.

Therefore, according to the above-description, following advantages of the present invention can be found:

1. In the chisel-edgeless design, the central edge having cutting function reduces the possibility of generating drag, further improve drilling speed and feed rate.

2. Said inserts not only have cutting function, but also more central location function with higher stability so as to suit to high-speed drilling depth hole to get the ratio of L/D to 10 (the conventional L/D ratio is 4 in max).

3. Reducing the production cost, using economic insert makes the stem can be used repeatedly.

4. Using insert do not need to remedy the edges, and replace rapidly, and have precise size location simultaneously.

5. Said both inserts are arranged in balance arrangement, so the cutting resistances exerting on the bit are uniform without generating vibration and enlarging aperture any more.

6. In accordance with large sized drill, the inserts arrayed in step arrangement have stage-cutting and breaking chips functions so as to reduce the volume of chip for accelerate chip removal.

7. The back side of said side of the insert is taken the curved shape in design, thereby to be getting supporting from the side wall of the boring hole as drilling.

8. When the side of said polygon insert is located on the outside, it has not cutting function, but supporting function, hence the cutting edge will not be blunted; when said side is located on the center of said stem shift, it plays the role of inner edge having cutting function; when said inner edge and the bottom edge are blunted, said insert can be shifted an other corner to continue using; the benefit of making said insert into multi-edge is on bringing the multiple edges into full play and saving the production cost.

I claim:

1. A speed chisel-edgeless common bit including a stem having two inter-alternative coordinated cutting slots, a V-shaped notch at the tip central overlapping portion of said both cutting slots, and two holding slots and two screwing holes built upon the tip ends of said cutting slots separately for retaining two inserts individually.

2. A speed chisel-edgeless common bit as claimed in claim 1, wherein the back side of the side of said insert is taken curved shape.

3. A speed chisel-edgeless common bit as claimed in claim 1, wherein every corner of said insert is built as same as said side in shape to form multi-edge insert for using multiply.
